(19) United States
(12) Patent Application Publication
(10) Pub. No.: US 2025/0033571 A1
(43) Pub. Date: Jan. 30, 2025

(54) Vehicle Having a Storage Compartment

(71) Applicant: Bayerische Motoren Werke Aktiengesellschaft, Muenchen (DE)

(72) Inventor: Florian ZANOLI, Altdorf (DE)

(21) Appl. No.: 18/715,158

(22) PCT Filed: Nov. 18, 2022
(86) PCT No.: PCT/EP2022/082370

§ 371 Date: May 31, 2024

(30) Foreign Application Priority Data
Dec. 20, 2021 (DE) 10 2021 133 777.1

(51) Int. Cl. B60R 9/06; B60L 53/16

(52) U.S. Cl. CPC B60R 9/065; B60L 53/16

(57) ABSTRACT

A vehicle has a separate storage compartment for an electrical charging cable outside the passenger compartment and outside the luggage compartment. The separate storage compartment is accessible from the outside of the vehicle through an opening, the opening being closable with a flap.

### BACKGROUND AND SUMMARY

The invention relates to a vehicle having a storage compartment for an electrical charging cable.

Modern motor vehicles ever increasingly have an electric drive motor which draws its energy from a rechargeable battery which is installed in the vehicle. In order to charge the battery, the motor vehicle must be connected via an electric charging cable to a stationary charging station. Many motor vehicles have a plug receptacle which can be covered with a pivotable flap when not in use. The electric charging cable for charging is usually stowed in the luggage compartment, which charging cable on one hand is plugged into the plug receptacle to charge the battery and on the other hand can be connected to the charging station.

A motor vehicle with a storage compartment in the vehicle interior below a rear shelf is known from DE 10 2019 007 961 A1. An electric charging cable can be accommodated in the storage compartment when it is not required.

The object of the invention is to create a vehicle with a storage compartment in which an electric charging cable can be accommodated when it is not required to charge the vehicle.

The object is achieved with a motor vehicle having a storage compartment in accordance with the independent claim(s).

According to the invention, a vehicle has a separate storage compartment for an electric charging cable outside the passenger compartment and outside the luggage compartment, the storage compartment being accessible from the exterior of the vehicle through an opening, the opening being closable with a flap. An electric charging cable is exposed to all weathering influences during the charging process and can, for example, become wet and dirty. The separate storage compartment according to the invention enables accommodation outside the passenger compartment and the luggage compartment so that neither the passenger compartment nor the luggage compartment becomes wet and/or dirty when stowing the electric charging cable.

The vehicle is preferably a motor vehicle with a front end in front of the passenger compartment and a rear end behind the passenger compartment. A luggage compartment in the sense of this invention is a luggage compartment in the front or rear end which serves to accommodate luggage of the passengers. The storage compartment which is separate from the luggage compartment is arranged in the front or rear end. The flap is expediently arranged in a vehicle side wall, the flap in the closed position being flush with the surface of the surrounding vehicle side wall. In this manner, the flap integrates inconspicuously into the visual appearance of the side wall. The storage compartment arranged behind the flap is not visible when the flap is closed.

In an alternative advantageous configuration, the flap at least partially covers the front end on the upper side so that the storage compartment is located in the front end below the flap. In the case of an opened flap, the storage compartment is thus open from above to accommodate the electric charging cable. This arrangement of the storage compartment is particularly comfortable to use. In one special configuration, the flap simultaneously forms a front flap which covers the entire upper side of the front end. The storage compartment ideally adjoins an end wall which separates the passenger compartment from the front end. In this manner, the end wall can simultaneously form a side wall of the storage compartment.

The storage compartment is advantageously cylindrical or cuboid. In the case of a closed flap, it forms a container which is closed on all sides. In the case of a cylindrical storage compartment, it is circumferentially closed with a side wall which forms the shell surface of the cylinder. A cylindrical storage compartment furthermore has a base, the cover is formed by the flap. In the case of a cuboid storage compartment, four mutually adjoining sides are provided as well as a base. The flap forms the sixth side of the cube.

The storage compartment preferably forms a flat portion of a side wall of the vehicle. This flat portion advantageously has on one side a plug receptacle for the electric charging cable. The flat portion is displaceable between a use position, in which the side with the plug receptacle is accessible from the outside of the vehicle, and a non-use position, in which the side with the plug receptacle faces the storage compartment. In the case of currently known motor vehicles, a fixedly installed plug receptacle is usually provided which can be covered with a charging flap. In contrast, in the case of the arrangement according to the invention, the plug receptacle is integrated into a displaceable, flat portion which forms a part of the side wall of the vehicle. The flat portion in the non-use position is ideally flush with the surface of the surrounding side wall of the vehicle so that it is integrated into the surrounding side wall in a visually inconspicuous manner. In one particularly advantageous configuration, the portion is formed by the flap.

An exemplary embodiment of the invention is represented in the drawings, on the basis of which exemplary embodiment the invention is described in greater detail below.

### BRIEF DESCRIPTION OF THE DRAWINGS

FIG. 1 a perspective view of a motor vehicle with a storage compartment in which an electric charging cable is stored;

FIG. 2 is a perspective view of the motor vehicle shown in FIG. 1, wherein the electric charging cable is removed from the storage compartment;

FIG. 3 is a further perspective view of the motor vehicle shown in FIG. 1, wherein the electric charging cable is removed from the storage compartment; and

FIG. 4 is a further perspective view of the motor vehicle shown in FIG. 1, wherein the electric charging cable is stored in the storage compartment.

### DETAILED DESCRIPTION OF THE DRAWINGS

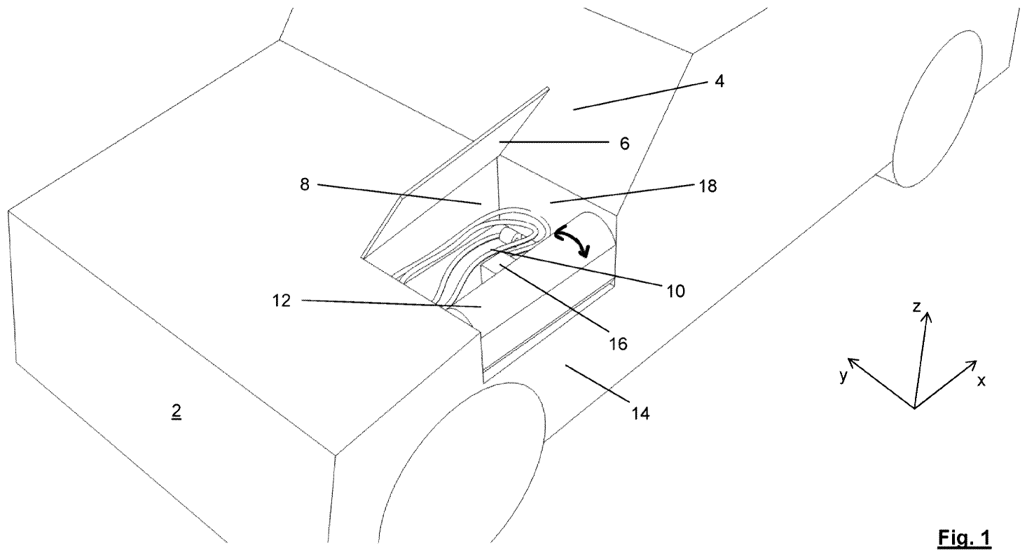

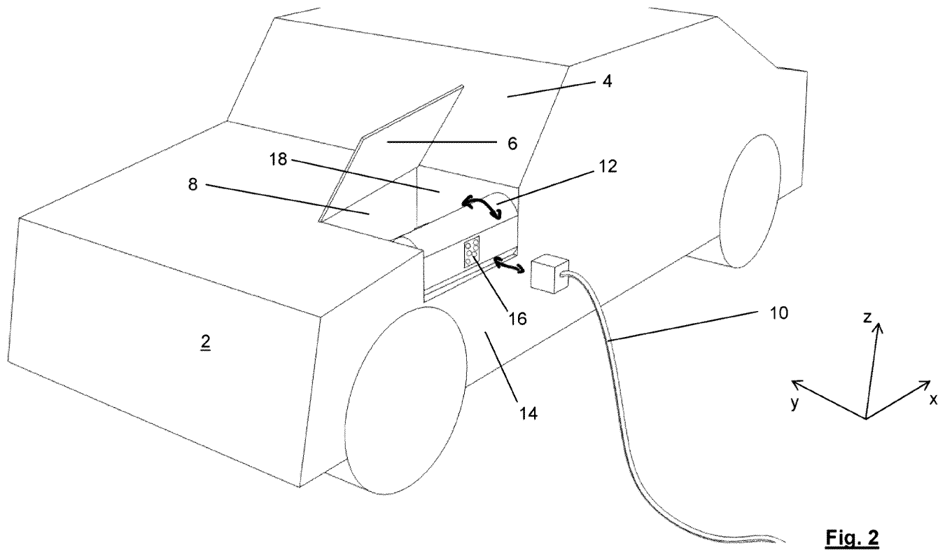

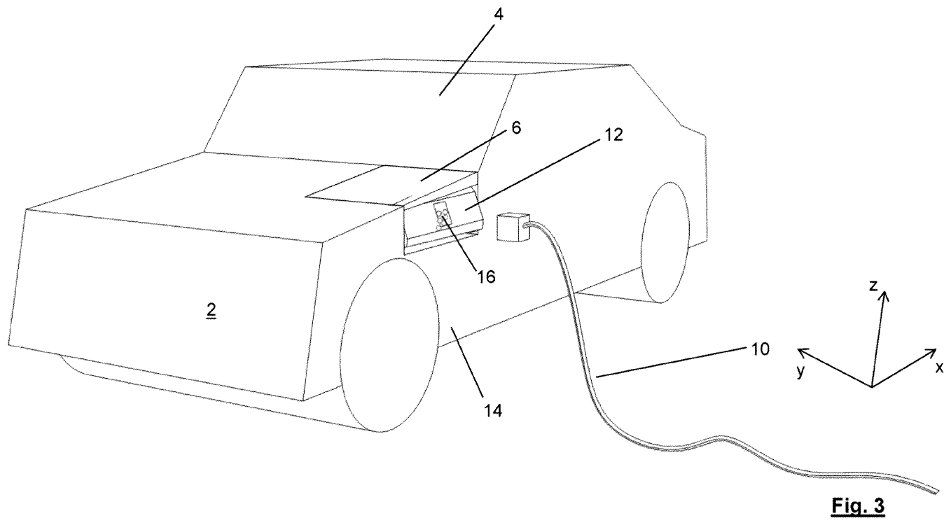

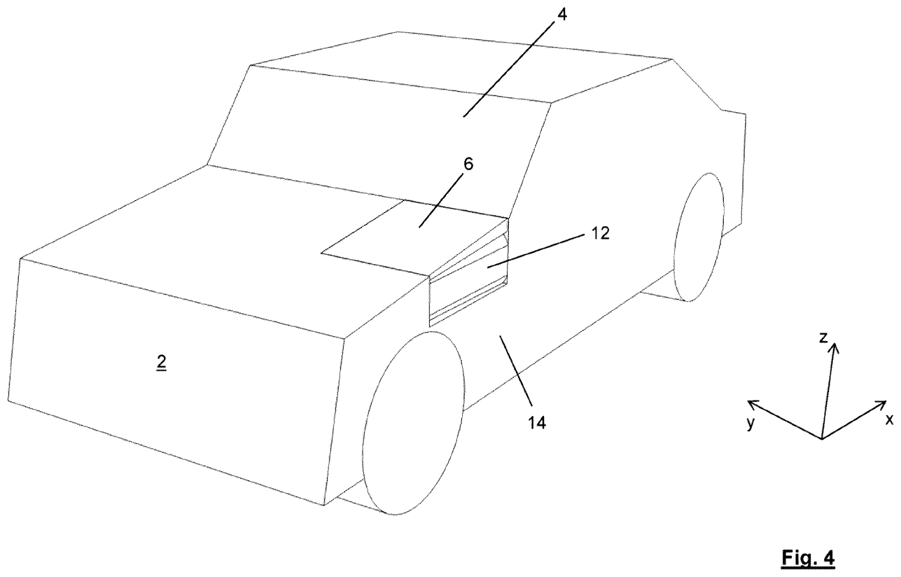

In each case a perspective view of a front end 2 of a passenger motor vehicle can be seen in FIGS. 1-4. The front end 2 is located in front of the passenger compartment as seen in the longitudinal direction of the vehicle x, while a rear end is located behind the passenger compartment. A view obliquely from the front can be seen in the figures. An end wall (18) which extends substantially in the transverse direction of the vehicle y and in the vertical direction of the vehicle z and separates the front end from the passenger compartment is located between the front end 2 and the passenger compartment. As seen in the longitudinal direction of the vehicle x, the passenger compartment is delimited in the front and upper region by a windshield 4 which extends obliquely upwards and to the rear. The front end 2 is covered as seen in the vertical direction of the vehicle z at the top by a hood. The hood has a flap 6 in a lateral region. The flap 6 can be pivoted from the opened position represented in FIG. 1 and FIG. 2 about a pivot axis, which extends in the longitudinal direction of the vehicle x, into a closed position. In the closed position represented in FIG. 3 and FIG. 4, the flap 6 adjoins the neighboring regions of the hood in a flush manner so that the closed flap 6 looks like a component of the hood.

A substantially cuboid storage compartment 8 is arranged below the flap 6 in the front end 2. This storage compartment adjoins the end wall 18 at the rear as seen in the longitudinal direction of the vehicle x. The end wall 18 can in this case even form the rear side wall of the storage compartment 8. The flap 6 is pivotable about at least one hinge which is fitted on an edge region, facing the center of the vehicle, of the flap 6. The pivot axis runs in the longitudinal direction of the vehicle x. For opening, the flap 6 is pivoted upwards about the pivot axis. In the case of an opened front flap 6, the storage compartment 8 is accessible from above so that an electric charging cable 10 is placed into the storage compartment 8 or removed from it. For this purpose, the storage compartment 8 is dimensioned so that the electric charging cable 10 easily finds space therein.

The storage compartment 8 arranged in the front end 2 outside the passenger compartment and outside a luggage compartment enables safe and protected accommodation of the electric charging cable 10 when not in use without, under certain circumstances, a dirty charging cable making the passenger compartment or the luggage compartment dirty in the case of storage in the storage compartment 8.

The storage compartment 8 simultaneously forms a flat portion 12 of a side wall 14 of the front end 2 of the vehicle. The side wall 14 forms the lateral delimitation which is visible from outside and is often colloquially referred to as a fender. The flat portion 12 has two sides. A plug receptacle 16 for the electric charging cable 10 is located on one of the two sides. The flat portion 12 can be displaced between a non-use position in which the side with the plug receptacle 16 faces the storage compartment 8 and a use position in which the side with the plug receptacle 16 is accessible from the outside. In FIG. 4, the flat portion is located in the non-use position, the plug receptacle 16 projects into the storage compartment. The side opposite the plug receptacle 16 of the flat portion 12 adjoins the surrounding side wall 14 flush with the surface and integrates harmoniously into the appearance of the side wall 14 so that the flat portion 12 is inconspicuous from the outside. In FIG. 2 and FIG. 3, the flat portion 12 is in the use position in which, in order to charge the vehicle, the electric charging cable 10 is plugged with one end into the plug receptacle 16 and with the other end can be connected to a charging station. The flat portion 12 can be pivoted by a rotary rotational movement between the use position and the non-use position.

In this case, it is particularly advantageous that, in the event of a rotation of the flat portion 12 from the non-use position into the use position or vice versa, the electric charging cable 10 can remain plugged in the plug receptacle 16.

1.-10. (canceled)

11. A vehicle, comprising:
a separate electric charging cable storage compartment, located outside of a passenger compartment and outside of a luggage compartment of the vehicle, wherein
the electric charging cable storage compartment is accessible from an exterior of the vehicle through an opening; and
a flap configured to open and close the opening of the electric charging cable storage compartment.

12. The vehicle according to claim 11, wherein
the vehicle is a motor vehicle with a front end in front of the passenger compartment and a rear end behind the passenger compartment, and
the electric charging cable storage compartment is arranged in the front or the rear end.

13. The vehicle according to claim 11, wherein
the flap is arranged in a vehicle side wall and, in a closed position, is flush with a surface of a surrounding vehicle side wall.

14. The vehicle according to claim 12, wherein
the flap at least partially covers the front end on an upper side, and
the electric charging cable storage compartment is located in the front end below the flap.

15. The vehicle according to claim 14, wherein
the electric charging cable storage compartment adjoins an end wall which separates the passenger compartment from the front end.

16. The vehicle according to claim 11, wherein
the electric charging cable storage compartment is cylindrical or cuboid and is delimited circumferentially with at least one side wall and/or the flap.

17. The vehicle according to claim 11, wherein
the electric charging cable storage compartment forms a flat portion of a vehicle side wall of the vehicle.

18. The vehicle according to claim 17, wherein
the flat portion has, on one side, a plug receptacle for an electric charging cable, the flat portion being displaceable between a use position, in which the side with the plug receptacle is accessible from outside of the vehicle, and a non-use position, in which the side with the plug receptacle faces the storage compartment.

19. The vehicle according to claim 18, wherein
the flat portion, in the non-use position, is flush with the surface of the surrounding vehicle side wall of the vehicle.

20. The vehicle according to claim 18, wherein the flat portion is formed by the flap.
